(19) United States
(12) Patent Application Publication
(10) Pub. No.: US 2021/0042662 A1
(43) Pub. Date: Feb. 11, 2021

(54) Interactive Information Capture and Retrieval with User-Defined and/or Machine Intelligence Augmented Prompts and Prompt Processing

(71) Applicants: Ninghua Albert Pu, Walnut, CA (US); George Nicholas Pu, Walnut, CA (US)

(72) Inventors: Ninghua Albert Pu, Walnut, CA (US); George Nicholas Pu, Walnut, CA (US)

(73) Assignees: Ninghua Albert Pu, Walnut, CA (US); George Nicholas Pu, Walnut, CA (US)

(21) Appl. No.: 16/986,250

(22) Filed: Aug. 5, 2020

Related U.S. Application Data
(60) Provisional application No. 62/883,589, filed on Aug. 6, 2019.

(51) Int. Cl. G06N 20/00; G06Q 30/02; G06Q 10/10; G06Q 50/00; G06F 40/186

(52) U.S. Cl. CPC G06N 20/00; G06Q 30/0201; G06Q 30/0203; H04L 67/10; G06Q 50/01; G06F 40/186; G06Q 10/101

(57) ABSTRACT

Interactive information capture and retrieval via user-defined and/or machine intelligence augmented prompt and prompt-processing for ease of user information extraction and consumption. The disclosed system and methods effectively leverage human actions and cognitive processes with integration with market available AI/ML technologies and models for faster and more accurate information extraction via user instructed and/or directed prompts. It also leverages the unique information elements captured via the prompt-based processing for enhanced information retrieval and rendering experiences.

### CROSS REFERENCE TO RELATED APPLICATIONS

This application claims priority to U.S. Provisional Patent Application No. 62/883,589, filed on Aug. 6, 2019.

### FIELD OF INVENTION

The present invention relates to easing the process of information capture and retrieval from digital and/or physical sources with digital devices, via user interactions with a set of user-defined and/or machine intelligence augmented prompts pertaining to raw target information.

### BACKGROUND

There are multiple ways of capturing information seen or heard via digital devices such as through mobile phones or personal computers. Information intended to be captured can be from digital sources such as online or digital media, or physical sources like paper or print media. Traditionally, information capture via digital devices are carried out with manual keyboard entries, image captures via cameras or scanners, or sound or video recordings.

Information capture via manual keyboard entries are typically accurate and relevant to a user's information capture needs. However, it can also be sparse and limited in covering the entirety of the information heard or seen due to lags and slowness in manual entries as information is being presented and processed by a human's perceptual and cognitive capabilities.

For images captured via a camera, the captured images will need to be further processed in order to extract the relevant text and/or image information for the intended information needs. The process may often times involve additional input time through manual key entries in gathering and organizing the information from the images.

Video or sound recordings may capture the information in its entirety. However, this information capture approach is tedious and usually requires going through the recording again, with pauses or repeats sometimes, to extract and capture the desired information with proper organization.

Technologies in OCR (Optical Character Recognition) and AI (Artificial Intelligence) can also be utilized to process the image or voice recordings for faster information capture. OCR has been very effective in recognizing text from scanned documents. Speech and image recognition technologies offered by AI cognitive service providers such as Google, Microsoft, and many others can sometimes produce over 90% accuracy in recognizing text, images and/or objects seen and/or heard. Though automated text extraction from images and speech to text from voices and sounds greatly reduce the time and process of gathering text information compared to manual processing, the information extracted may be excessive, irrelevant, inaccurate, and/or unorganized, which will result in additional manual processing.

Text processing and Natural Language Processing (NLP) technologies perform pattern matching, entity analysis/recognition, and text analytics into word relationships, topics and semantics of a given text. It offers better extraction of information given a target information. However, these technologies are still maturing, and custom training at the coding and modeling levels are often times required for accurate and relevant extraction of a given information source.

There are also purpose-built text extraction technologies in the market that help users extract certain types of information with simple and/or one-click scenario(s). The Google Translate application speaks to such an example where a user can take an image and point to the text areas of the image for the intended text extraction via Google's image recognition service. Another example is Microsoft's tool for extracting a picture of a spreadsheet into a spreadsheet format by point and click. These offerings are purpose built for specific scenarios and not intended for common information retrieval from varied information sources with one or multiple information types.

Retrieval of captured information is typically performed via search or browse for content on a digital device, information sources across networked devices, and/or cloud storage. The desired information is then displayed on a digital device for user consumption.

To retrieve related information captured at a certain location, during a certain period of time, for a particular subject such as an academic course, etc., the individual may need to manually search and gather based on if these related information are captured under the same directory, with the same or similar tags, adhering to a consistent naming convention, etc. Otherwise, retrieval of related information can be difficult and time consuming.

Advancements in human-computer interface technologies such as Apple's Siri or the Google Assistant help user interaction(s) and ease of use with voice instructions for information capture and retrieval. They do not fundamentally address the challenges as described in the previous paragraphs, indicating gaps in efficiency, accuracy, and/or effectiveness with the prior art to effectively and quickly capture information seen or heard with accuracy and relevancy. There also exists a gap in information retrieval tools/technologies for ease of finding not only the right information but also relevant information, reflecting how and when the relevant information is captured.

### SUMMARY OF THE INVENTION

Embodiments of the present invention include three methods and a corresponding system and computer programs for accurate, relevant, and effective information capture and retrieval with user-defined and/or machine intelligence augmented prompts and prompt processing.

One embodiment of the present invention discloses a method for interactive information capture via a set of predefined prompts grouped and configured for specific instances or types of information such as lecture material from a student's course, deals from nearby restaurants, or print ads from local businesses. The method is comprised of user interactive gestures for specifying and structuring the desired information area(s) or segment(s) on a user's device screen they would like to capture, associations of the specified information area(s) or segment(s) with the prompts as per the selected prompt-set for the target information source, heuristics and predictive models whenever applicable for prompt and/or user interaction assistance, as well as applicable image processing, speech recognition, and/or natural language technologies for information extraction. The prompt-based and user interactive information capture method with applicable human computer interface techniques not only offer users the convenience of point and click for faster and easier information capture, but also improves information capture's accuracy and relevancy. Since the prompt-set for the target information is typically purpose-constructed by the said system and/or defined by the user, the captured information is already organized for ease of presentment and organization.

Specifications of the desired information area(s) or segment(s) can be carried out via user gestures or stylus pen interactions on a device's screen, text commands via a device keyboard, and/or voice commands via a device microphone. Screen touches, text or voice commands are used with reference to information area(s) or segment(s) mapping and interpretations, if applicable, to indicate information area(s) or segment(s) of interest as on a device's screen, which can be in the form of boxed, circled, or free formed areas drawn or with the corresponding points or line positions called out, start and end positions on the screen, highlights of the areas of interest, a centroid of an area extending in radius or in width by height, or any other means that can specify an area of interest on a screen (e.g. even with mind reading such as experiment with Neuralink for brain and device interface).

Another embodiment of the present invention discloses a method for creating or modifying a prompt-set targeting an information source, which can be at the instance or class/type level spanning across one or multiple spatial and/or temporal dimensions. Creation and/or modification of a new or existing prompt-set can be conducted by a single user, multiple users, and/or system users, with or without machine intelligence augmentation. The creation or modification process also includes manual and/or machine intelligence assisted prompt organization and linkage with other prompts or prompt-sets, as well as observation(s) and learning(s) from user interactive information capture and retrieval processes.

Another embodiment of the present invention discloses a method for retrieving captured information with additional browse, search, and/or filter dimensions specific to the disclosed information capture process and prompt-set definition methods. It provides additional dimensions and information rending mechanisms for information presentment for better slice and dices and understanding of the captured information. It also connects and arranges the related information as captured for improving the ease of navigation, presentation and knowledge acquisition processes.

Another embodiment of the present invention discloses a system for the disclosed methods to execute and operate on. It comprises of digital devices for users to interact through a set of prompts for information capture, retrieval, as well as prompt-set template creation and modification processes and procedures, collection(s) of user-defined and/or machine intelligence augmented prompts and prompt-set templates hosted on the digital devices and/or external systems, heuristic and predictive models and natural language processing and text analytics services that are custom-developed and/or from 3^{rd} parties to assist and augment prompt and template organization, assist in continuous technological improvement, and user interaction optimizations; 3^{rd} party AI cognitive services such as image recognition, speech to text, and text to speech which can be hosted on cloud or on-device; target information sources can be online, digital, or physical media.

### BRIEF DESCRIPTION OF DRAWINGS

FIG. 1 is a block diagram illustrating an example of the functional components of the system and computer programs.

FIG. 2 is a flow chart showing an example of the interactive information capture via user-defined and/or machine intelligence augmented prompts and prompt processing.

FIG. 3 is a flow chart showing an example of the prompt-set template creation and modification manually or via heuristic and machine learning models.

FIG. 4 is a flow chart showing an example of information retrieval from the captured information collection, assisted with insights, heuristics, and predictive models gathered through the capture and prompt-set template creation or modification processes.

### DETAILED DESCRIPTION

The invention is consisted of one system and three methods for interactive information capture and retrieval with user-defined and/or machine intelligence augmented prompts and prompt processing.

The “user” in user-defined refers to any type of user who may interact with the disclosed system and methods at any level or role. Examples of user levels or roles include personal user, group user, system user, super-user, and power user.

Users at the personal level are individual digital device users who perform information capture, retrieval, and/or information capture prompt-set template creation or modification, which is tailored to the individual's needs. Users at the group level refer to multiple device users collaborating implicitly or explicitly in defining prompts and/or prompt-set templates for individual or group needs. Impact of the user-defined prompts, prompt-set templates and the applicable processing would be limited to the individual user or group level. Users at the system levels may define and modify prompts, prompt-set templates, and the related processing with impact to the entire system and/or disclosed methods and/or to a certain portion of the system and/or disclosed methods. Super users and power users are defined by the system and the implemented method's process administrators with certain creation and edit privileges to a portion of the system or method processes.

Machine intelligence refers to custom-developed proprietary and/or third-party heuristic and/or machine learning models for intelligent prompt definition, organization, and processing. It also refers to generic cognitive AI services such as image recognition, speech to text, natural language understanding and generation services custom-developed and/or from a third-party, as well as custom-developed and/or third-party purpose-built image recognition, speech to text, and natural language processing and/or text analytics services for information processing. Third-party refers to any entity that offers the above referenced machine intelligence products or services in an interaction that is primarily between the disclosed system and methods provider and users of the disclosed system and methods. Examples of third-party entities include commercial vendors, open source organizations or communities, research and/or industry organizations and consortiums who offer products or services for a fee or for free.

Heuristic models refer to any approach to problem solving, learning, and/or discovering that employs a practical method not guaranteed to be optimal or perfect but sufficient enough for the immediate goals. Examples of heuristic models include using a rule of thumb, an educated guess, an intuitive judgement, a guesstimate, stereotyping, profiling, using common sense and as well as using rules or knowledge-based processing in support of the disclosed system and methods.

Machine learning models refer to custom-trained and/or third-party models that leverage machine learning and deep learning algorithms that parse data and learn from the parsed data for insight, predictions, and recommendations.

Prompts are labels or tags defined by users and/or augmented by machine intelligence that can interact with users to denote, reference, or group a set or type of information as determined noteworthy by a user. The set or type of information can be compromised of one or multiple characters, words, sentences, paragraphs, sections, chapters, books, images, voice recordings, web or digital sources of any MIME types, or any combination of the above.

Prompts can also be related to one another as siblings, parts of multiple relational nesting, or associated with different relationship types or affinity scores. Different prompts can be combined together as a prompt-set template, which is a container of prompts with varied relationships. They can be defined by a user and/or with machine intelligence augmentation, targeting a specific raw information or information type such as print ads from a restaurant, digital ads from online deals sites, or information captured and retrieved in a student's academic class.

Prompt processing refers to extraction, organization, and/or formatting and styles of the desired information out of one or multiple raw information contents as denoted by the specified prompt via human cognitive and/or machine intelligence processes per the prompt's associated information extraction, organization, and/or formatting configurations.

### Prompt-Based Interactive Information Capture and Retrieval System

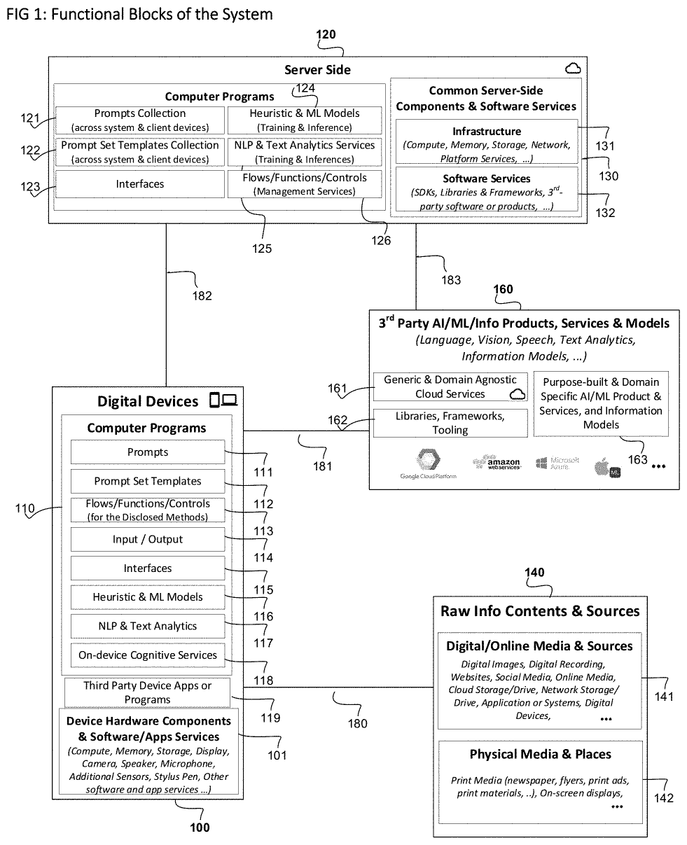

The said system, as exemplified in FIG. 1, comprises of the following:
Digital devices (100): mobile devices and personal computers that are further comprised of:
   Computer programs (110) running on digital devices with:
      prompts (111), prompt-set templates (112),
      computer implementation(s) of programming flows, functions, and controls for the disclosed methods (113),
      input and output (114) functions for:
         capturing user interaction gestures, stylus pen interactions, and other input mechanics such as text or voice commands via keyword(s) or a device's microphone, device's camera, or other device sensors that can receive or detect a user's input that may signal a command or instruction,
         output via gathering, organizing, and rendering the desired information for display as defined by the disclosed methods,
      interfaces (115),
      heuristic and ML models (116) & NLP and text analytics (117) that may be either custom-developed, from 3^{rd} party service providers, running on-device as part of the computer program, or from another computer program, external system, or public cloud,
      On-device cognitive services (118).
   Third party device apps or programs (119) that may interface with computer programs (110).
   Device's hardware components and software/application services (101) refer to:
      common device configurations and hardware components such as the device's compute components such as CPU and/or GPU, display, memory, storage capabilities, camera, speaker, microphone, additional device sensors, stylus pen, if applicable, etc., which can be utilized by one or multiple components of the computer programs (110),
      other software and/or applications' services running on the device, which may vary per user's preferences and device setup, that might utilize the disclosed methods for information capture and retrieval.
Server-side (120) computer programs and common server-side components and software services (130) running as cloud services, wherein:
   Server-side computer programs are further comprised of:
      A prompt collection (121) and prompt-set template collection (122) across the system and client devices that are user-defined and/or machine intelligence augmented,
      interfaces (123) that serve server-side (120) services enabled by the said computer programs or consumer services from AI/ML/Data Products and Services (160),
      heuristic and ML models (124) and NLP and Text Analytics services (125) that might be custom-developed and/or implemented by third-party products or services,
      flows/functions/controls (125) for management services on the client-side programming implementations for the disclosed methods.
   Common server-side components and software services (130) are further comprised of:
      common server-side infrastructure components and services (131), including compute, memory, storage, network, platform services, etc.,
      server-side software components and services (132), including SDKs, libraries & frameworks, 3rd-party software or products, etc.
   computer programs and common server-side components and software services (130) can be implemented by leveraging Infrastructure as a Service (IaaS), Platform as a Service (PaaS), Function, Data, Machine Learning, and any applicable as a Service Cloud offering commonly available from the market place.
Raw information sources (140) containing raw information that a user is interested in capturing into their digital device, which is comprised of the following types:
   Digital media (141) with information stored as any of the MIME (Multipurpose Internet Mail Extensions) types, internet content types or sub-types from digital/online sources, such as digital images, digital recordings, digital content from websites, social/online media, cloud/online storage or drives, network storage or drives on a user's digital device(s), inside application(s) or system(s), etc.,
   Physical media (142) seen or heard, such as print papers (newspapers, flyers, print ads, print materials, etc.), on-screen displays, post(s) on a wall, etc.
Third-party Artificial Intelligence (AI), Machine Learning (ML), Information Products, Services, and Models (160) for language, vision, speech recognition and processing, text analytics, machine learning, and information models services, comprised of:
   Generic and domain agnostic cloud services (161): AI/ML cognitive services, data models, cognitive and semantic models that are generic and not associated with any specific industry or scientific domain by AI/Data technology providers such as Google, Amazon, Microsoft, and other applicable third-party service providers,
   Libraries, frameworks, and/or tooling (162) that are provided as products or services that can be consumed as cloud services, implemented and run on-device (100), and/or implemented and run on server-side (120),
   Purpose-built and domain specific AI/ML products or services and information models (163) for a specific industry, consumer, or academic domain such as a high school algebra course, college course for introductory statistics, online electronics data and semantic models, and any other domain and/or purpose specific AI, ML, and Data products or services.
Interfaces between the major system constructs (180, 181, 182, 183).

### Interactive Information Capture via User-defined and/or Machine Intelligence Augmented Prompts and Prompt Processing

Capturing information through a digital device from raw information sources (160) is usually performed during and/or after the time interval of when and where the target information is presented to a user.

The capturing process of turning raw information from digital or physical sources into processed/structured information pertaining to a user's capturing needs and information organization styles typically includes a plethora of activities. These activities include human sensory perception and cognitive capabilities in seeing, hearing, and/or comprehending the raw information, inputting the desired information into a digital device, and organizing the input information into a user-desired format and/or style. These activity types are sometimes repeated over a period of time in order to get an accurate and user-preferred information organization of the captured and processed information, especially if the raw information is complex and spanning across multiple digital and/or physical files or sources.

Human sensory perception and cognitive capabilities refer to a human's ability to see, hear, reflect, remember and/or digest and process the raw information during or after the event of when the raw information is presented.

Input mechanics of capturing the information into a digital device refer to human computer interfaces, device to device interfaces, and system to device interfaces that can enter, specify, and/or send data to and/or from a digital device.

Human computer interfaces with digital devices refer to the input and output mechanics that support human interactions with the digital devices. Examples of human computer interfaces include data entries via a physical or virtual keyboard, voice entries and recognitions via the device's microphone and the applicable voice recognition computer programs such as on-device cognitive services (118) or AI/ML services (160) in the cloud, interactions with the device's screen and/or other applicable sensory devices with gestures or a stylus pen with actions such as touch(es), point and click(s), writing(s), and/or drawing(s), brain-machine interfaces experimented currently for mind-reading by companies such as Neuralink, and any other device sensory and input mechanics that can be detected by the device and interpretable as screen positions and/or area specifications.

Input mechanics through device to device interfaces refers to device-to-device communications that can transfer data from one device to the other via wires or wirelessly. Examples include a direct wired connection between two devices for file transfer, Bluetooth, NFC (Near-field Communication), Airdrop between Macs and iOS devices, and any other communication types or protocols that support data transfer between two devices.

Input mechanics for system to device interfaces refer to any device's interfaces with server-side (120) computer programs, components, and/or software services, AI/ML/Information products, services, and models (160), and Digital/Online Media & Sources (141) that can share, push, send, and/or be invoked for data exchanges with the digital devices.

For simple raw information capture such as a print or online ad from a restaurant, a user can simply take a picture or share the ad digitally to themselves, with or without adding a tag, note, and/or reminder for when to act on the captured ad. The capture process may take a couple of seconds or minutes if additional tag(s), note(s), rearrangement(s), or reminder(s) are added. However, if information such as an advertised price or a promotion's end date is to be extracted out of the ad, additional effort and time will be required from the user to enter the necessary information with correct format and/or tag(s).

For complex and raw information captured such as lecture materials and notes from a class, the capture process while class is ongoing can be time intensive and consuming, which can be a burden for users wanting to keep up with their instructor's pace but also gather and capture insight(s) from the presentation. There are lots of cognitive and manual activities required to capture, process, and organize the raw lecture materials in the proper format(s) and/or style(s) that tailor to a user's personalized learning habits and preferences. Often times, information captured from classes are not represented and organized in a way suited to a student's learning habit or style, due to the constraints in time and effort needed for transforming the raw class information into formatted information, resulting in a less than desired learning experience achieved.

Advancements in AI help in text extraction, labeling, face and object recognition(s) from images, speeches, and/or texts in different MIME types have arrived. However, there is still no general-purpose AI capabilities available in the marketplace to achieve or appear close enough to the desired level of human cognitive processing of information into concepts, topics, and/or a person's internal learning model.

The disclosed method combines human and machine intelligence wherever necessary to conveniently and accurately capture raw information into processed information, aided by user-defined and machine intelligence augmented prompt-set template and the related prompt processing.

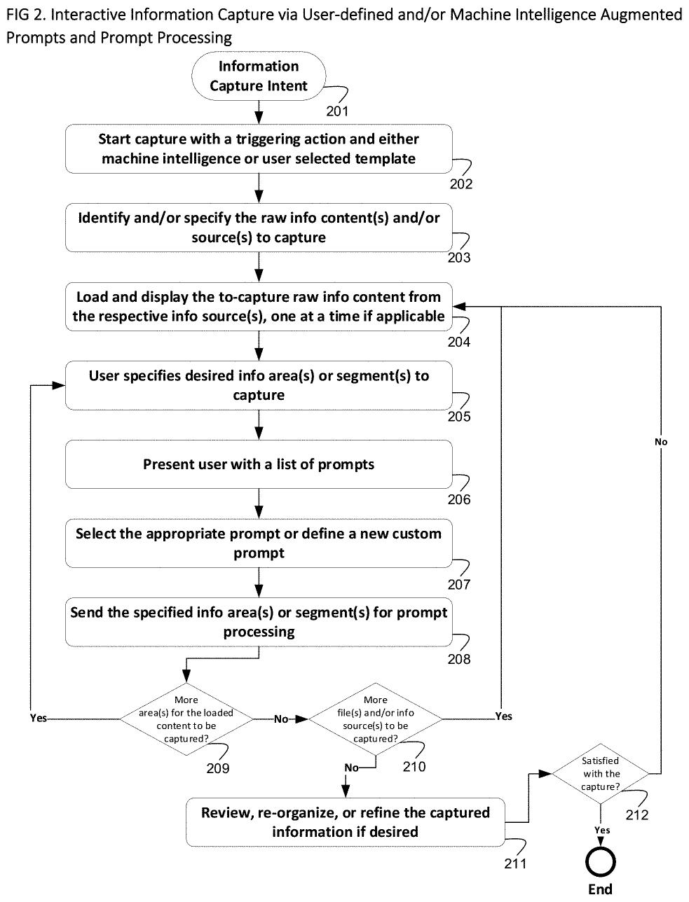

FIG. 2 illustrates the main process for the interactive information capture via user-defined and/or machine intelligence augmented prompts and prompt processing. Additional sub-processes and/or alternative processes are further elaborated in the rest of the section.

As illustrated, the main flow of the disclosed method starts from a user's intent to capture information (201), which is typically from one or multiple of the raw information sources (140), for example a shopping ad seen on a website or a flyer, or lecture notes from a class taken as images or downloaded as a PDF file.

Next, the user starts the capture process with a triggering action and a machine intelligence or user-selected prompt-set template (202). Triggering actions are interactions with the digital device that the computer program can receive and interpret as a call to initiate the start of the capture process. Examples include a button or menu action item click, command instruction via voice or keyboard, and any other input mechanics that can be intercepted as a triggering action.

A machine intelligence selected template can be explicitly and/or implicitly determined by the triggering action a user invokes, as well as the user interaction context per the moment with the digital device and physical environment, such as previous activities or actions before the triggering event, application scenarios under which the triggering action is invoked, time and location attributes, and any other factors that may help the computer programs (110) determine the appropriate template via heuristic and/or machine learning models.

Triggering actions can be mapped to any of the user's intents if the supporting template is available. The user always has the option to manually choose a preferred template in the case that the machine intelligence selected template is not suitable or preferred. In situations where a suitable template is not available, the user can choose a blank or modify a template with one or multiple custom-defined prompts for information capture.

With the capture template selected, the user needs to identify and/or define the raw information content(s) and source(s) to capture (203). Raw information content(s) and source(s) (140) can be either a simple file already stored on the user's digital device(s) or remotely in a cloud drive such as Box or Google Drive that the user has access to. Raw information content(s) or source(s) can also be captured through multiple files from one or multiple sources taken at one event or multiple events such as a recurring academic event during a quarter i.e. a professor's weekly Office Hours. Raw information contents can be of any MIME or internet media types that can be loaded for display on a digital device. Examples of raw information content types include text files, images in the appropriate image capture formats, a Microsoft word or PDF document, a voice recording, and any other MIME content types.

Raw information content(s) and source(s) can also be seen or heard physically but not digitally represented, such as through an ad on a flyer or website, lecture presentation slides projected onto a screen, or speeches being delivered. In such cases, the raw physical information will need to be collected and represented digitally, via camera and/or any other digital capture and/or recording devices, as one of the MIME or intent content types for loading and displaying on the digital device.

User identification and/or specification of the raw contents and sources can be conducted manually by selecting and specifying the applicable file(s) from one or multiple sources wherever applicable or available. It can also be specified and loaded via file load utilities with the to-be-loaded file attributes defined. Example file load attributes include image or audio files captured during a certain time period in a particular geographical location, files with certain naming conventions or timestamps, files at a location within certain sizes/lengths or associations with certain users, and any other attributes that can be used to identify the file locations. Additionally, identification and/or specification of the desired raw contents and sources can be augmented with machine intelligence with heuristic and/or machine learning models per the related triggering action and/or user interaction context and learnable patterns wherever applicable or available.

First, the digital device loads and displays the to-be-captured raw information content from the respective information source(s) one at a time, if applicable (204). The raw information content is then loaded via the computer programs' input and output (114) mechanics and/or interfaces (115) if the raw information does not reside on the digital device. If there are multiple files and/or information sources, the content will be loaded and displayed one at a time per the content type associated with the respective files. The respective raw content files can be loaded manually by the user and/or automatically per the raw information content(s) and source(s) specified by the user in step 203.

With the content in display on the digital device, the user then specifies desired information area(s) or segment(s) to capture (205). To specify an information area or segment of interest on a device's screen, it can be accomplished via input and output components that support human computer interactions with the digital devices. Examples of human computer interactions include data entries via a physical or virtual keyboard, voice entries and recognitions via the device's microphone and the applicable voice recognition computer programs such as on-device cognitive services (118) or AI/ML services (160) in the cloud, interactions with the device's screen and/or other applicable sensory devices with gestures or a stylus pen with actions such as touches, point and click, writings, and/or drawings (e.g. point and click, stylus pen actions, gestures and touches, etc.), and any other device sensory and input mechanics that can be the detected by the device, which are interpretable as screen positions and/or area specifications.

Examples of area specifications include drawing a boxed, circled, or free formed areas, touching and/or calling out the corner positions, begin and end position(s) or line(s), a centroid's position with an extending area in radius or in width and height, highlighting the text area(s), or any other means that can specify an area of interest on a screen with the human interactions.

Heuristic and machine learning models (116 and 124) can also be leveraged, if applicable and/or available, to detect and/or predict the likely text block(s) or visual area(s) that the user may intend to capture, based on the user's preferences and/or configurations, past behaviors, and/or collective screen interaction intelligence that can be custom-developed or implemented via third-party products or services.

After specification of one or multiple areas of the intended information to be captured, the user is presented with a list of prompts (206) per the selected template. The prompt list will have a “custom prompt” item in the case of no suitable prompt to select from the list.

The presented list of prompts may be all of the available prompts contained in the selected template in step 202, or a portion of the prompts pertaining to the to-be-captured content that can be configured by the user manually and/or determined by the heuristic and machine learning models (116 and 124) based on analysis of the to-be-captured content from the on-device and/or service-side NLP & Text Analytics (117 and 125), on-device cognitive services (118) and/or third-party AI/ML/Information products, services, and models (160).

The presented list of prompts can also be organized and presented top-down, nested in a hierarchical structure with parent or branch notes collapsible and expandable, appearing horizontally or vertically, stacked, circularly, and/or leveraging any other applicable visual display techniques that can be custom-developed or implemented via third-party products or services.

Afterwards, the user selects the appropriate prompt or defines a new custom prompt (207), if no suitable prompt is displayed, from the prompt-set template selected in step 202. A new custom prompt is defined by clicking on the custom prompt's item with a user-defined prompt's name or label. The user can choose to add more details to the prompt's name or label if desired.

Clicking on the applicable prompt will send the specified information area(s) or segment(s) for prompt processing (208), which refers to information processing, formatting, and/or styling per the prompt's associated information processing and formatting configurations pertaining to the prompt-set template the specified prompt is a part of.

Information processing refers to user-intended information gathering with applicable and available machine intelligence mechanics such as generic or purpose-built cognitive services for image, speech, and/or language recognition, heuristic and machine learning models, natural language processing and text analytics services. The machine intelligence mechanics can be custom developed or implemented via third party products or services running on-device and/or in the cloud on the server-side (120) or with the third-party AI/ML/Information products, services, and models (160).

Any applicable and available machine intelligence mechanics can be configured by default or through user-selectable processing options in association with a prompt and/or prompt referenced content MIME type. Configuration of the default machine intelligence mechanics can also be set during the template definition time, implicitly defaulted in association with the prompt-set template and/or the reference content MIME type.

For example, for image content(s) sent for prompt processing, the default information processing option may be text recognition and extraction via on-device cognitive services (118), image recognition with the generic and domain agnostic cloud services (161), and/or image recognition with the purpose-built and domain specific AI/ML products or services (163). Additional image processing options can also be configured and/or selected for prompt processing, such as object labeling, face recognition, logo or brand detection, and/or any other available or applicable image recognition services.

Images can also be configured with the option to be processed as-is, meaning that no image recognition or machine intelligence mechanics be performed.

For user intended text content processing or capturing, the selected text area may be configured to process as-is, with entity recognition, with additional options such as topic modeling, text classification, and/or processing via NLP or Text Analytics services (125) on the server-side or via third party AI/ML/Information product and services (160).

Formatting and styling for prompt processing refer to the look and feel of the content presentment by applying text and/or visual element formatting and styles. Text and/or visual formatting includes colors, character sizes and fonts, shapes and sizes for a visual element such as an image or drawing, alignments, indentations, positions, and/or any other available or applicable content formatting techniques that can be custom built and/or implemented by third party products and/or services.

Content styles refer to themes, arrangements of content elements such as ordering, nesting, grouping, headings, etc., content visualization techniques such top-down document view style with a table of contents, tabular display, tree view, linked graph view, etc., and/or any other content style techniques that can be custom built and/or implemented by third party products and/or services. Content styles can be applied to the entire captured content, one or multiple element(s) or area(s) within the content per the user's choices/preferences.

If more areas of the loaded content are to be captured (209), the user will go back to step 205 to continue the process. If more file(s) or information source(s) are to be captured (210), the user goes back to step 204 to continue the process.

After competing prompt-based interactive information capture for the desired raw information content(s), the user reviews, refines, re-organizes, and/or comments on the captured information if desired (211). Review and refine actions refer to viewing, making changes and/or modifying the interacted information, the underlying attributes and/or the meta-data. Examples include information content changes and edits, format changes, modifications to the related prompt(s) and/or prompt display preferences and options, edits of the information attributes and/or meta-data about the information, edits of the change logs, as well as any implicit and/or explicit logging of edits action, including when, where, how, and/or what.

“Re-organize” refers to any prompt's reassignment, repositioning within the capture template, ratings for information quality, linkages to other prompts or prompt-set template(s), and/or linkages to one or multiple information models wherever applicable or available. “Comment” actions refer to the user's actions about the interacted information such as noting, tagging, setting a reminder and/or linking event(s) for later review(s) or check-up(s), ratings, like(s)/dislike(s) pertaining to any aspect of the captured information.

During the information capture and interaction steps (201 through 211), the computer programs (110) that implement the disclosed method also observe the user interaction activities to gather insights and predictions to record and/or suggest improvement(s) in step 211, if applicable.

Insights and predictions can be gathered explicitly such as through user ratings of the extracted information. They can also be gathered and/or learned implicitly via observing the user's interactions individually, collectively, and/or comparatively via heuristic and machine learning models on-device or on the server-side (116, 124).

Next, if the user is satisfied with the captured information (212), the user completes and ends the interactive capture process. Otherwise, the user will go back to step 204 to continue capture and refine any additional information.

### User-defined and/or Machine intelligence Augmented Prompt-set Template Creation and Modification

The disclosed method enables user-desired and tailored prompts and prompt-set templates to be created or modified by users and/or augmented by machine intelligence. The method offers a convenient way for individual users to personalize their information capture needs for any raw information types they see, hear, or may have access to, aided with the prompts collection (121), prompt-set templates collection (122) whenever and wherever available, as well as with heuristic and ML models (124) and data/semantic/cognitive models with AI/ML/Data products and services (160) whenever and wherever applicable.

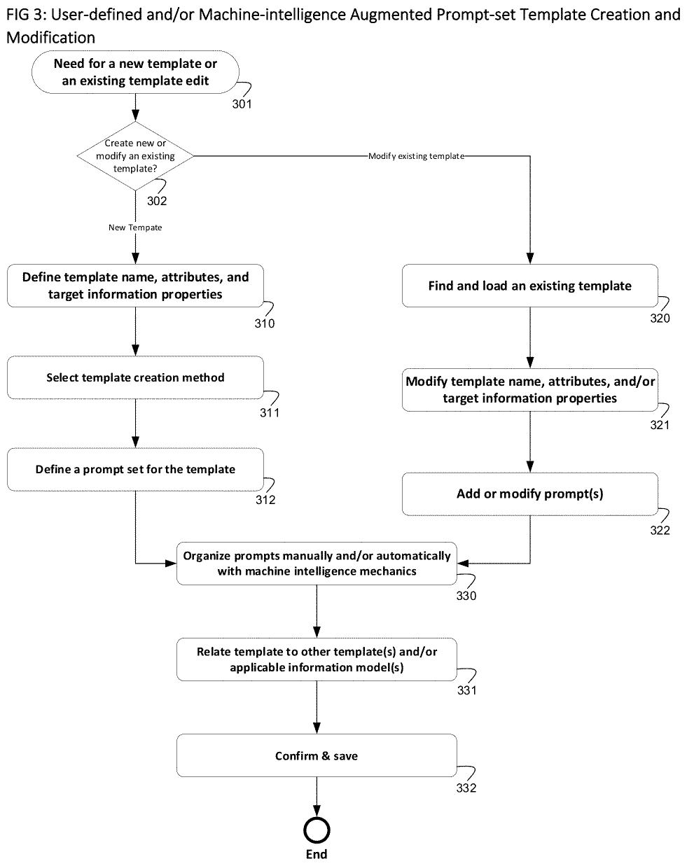

FIG. 3 illustrates the main process of creating and/or modifying a prompt-set as a capture template, which is a container for a set of organized prompts with the associated prompt pop-up, prompt visibility, and prompt processing configurations and instructions.

Prompt pop-up refers to configurations and triggering logic for when, what, where, and/or how one or multiple prompts may pop up for the user to select or act on, wherein:
when refers to the configuration(s) and/or the triggering logic(s) that controls the pop-up conditions to show one or multiple number of prompt(s),
what refers to which and how many applicable prompt(s) are shown for the user-interacted content and/or user-specified information area(s) or segment(s), which can be determined or explicitly set via the rules and conditions associated with the configuration(s) and/or the triggering logic(s), and/or determined by the heuristic and machine learning models (116 and 124) and/or the NLP and Text Analytics services (117 and 125) pertaining to any applicable content information, user activities individually or collectively, and/or information models that may be relevant to predict the applicable prompts to display,
where and how refer to the configurations and/conditions for how and where to display the applicable prompt(s) in the applicable and available formats and visual display styles.

Prompt pop-up conditions can be defaulted or determined by the method automatically with heuristic and machine learning models (116 and 124) whenever and wherever applicable and/or available.

Prompt visibility refers to conditions and controls for the visibility of a prompt after it is selected for prompt processing, which can be set via prompt visibility configurations such as removing after one or multiple selections, or via user controls during the information capture process to explicitly to make one or multiple prompts invisible. Prompt visibility can also be configured to leverage heuristic and machine learning models (116 and 124) to control visibility where and when applicable and available, for determination of a prompt's visibility during the information capture process.

Prompt processing refers to information processing, formatting and styling of raw information content associated with the information area(s) or segment(s) connected to a prompt specified by a user during the prompt-based information capture process (FIG. 2). Raw content(s) associated with the information area(s) or segment(s) on a digital device can be of any MIME types such as plain, html, json or xml text, word doc or pdf files, image files in standard graphic file formats, and etc.

Information processing refers to user-intended information gathering with applicable and available machine intelligence mechanics such as generic or purpose-built cognitive services for image, speech, or language recognition, heuristic and machine learning models, natural language processing and text analytics services. The machine intelligence mechanics can be custom developed or implemented via third party products or services running on-device and/or in the cloud on the server-side (120) or with third-party AI/ML/Information products, services, and models (160).

Formatting and styles for prompt processing refer to the look and feel of the content presentment by applying text and/or visual element formatting and styles. Text and/or visual formatting includes colors, character sizes and fonts, shapes and sizes for a visual element such as an image or drawing, alignment, indentation, positions, and/or any other available or applicable content formatting techniques that can be custom built and/or implemented by third party products and/or services.

Content styles refer to themes, arrangement of content elements such as orders, nesting, grouping, headings, etc., content visualization techniques such as table of content based document view style, tabular display, tree view, linked graph view, etc., and/or any other content style techniques that can be custom built and/or implemented by third party products and/or services. Content styles can be applied to the entire content, one or multiple element(s) or area(s) within the content per a user's discretion.

A template can be created for a particular information instance that may be specific to an event and/or information source such as a capture template for daily specials posted at a local store or for tasks assigned within a user's math class. A template can also be created across multiple information instances such as through an ad capture template for online deal sites or ad postings from local restaurants. Determination of such a template creation need is up to the user's preference, with assistance and/or recommendations from machine intelligence mechanics whenever available or applicable. A new template can be created at the individual user level, group user level for a common theme across multiple device users, and/or at the system level across all users.

As illustrated, the main flow of the said method starts from a need for creating a new information capture template or modifying an existing template (301). The need may be triggered manually by an individual user's intent to capture a particular information content and/or source they may have come across or had in mind. It may also be triggered by machine intelligence augmented observations and learnings from the user's information capture and retrieval activities, new developments or advancements of the heuristic and machine learning models (12), and/or availability of data/cognitive/semantic models that may have an impact on how to relate and reorganize prompts and prompt-set templates.

Based on whether the user's capture needs require creating a new template and/or modifying an existing template (302), it branches into defining raw information content and/or source attributes (310) or finding and loading an existing template to modify (320).

If the need is to create a new template, it continues to define the template's name, attributes, and target information properties (310). In addition to the template's name, the user can also define additional template attributes such as the description, category or theme, display style and format, usage patterns or guidelines, complexity, number of prompts, levels or types of related information to show, and/or any other attributes that may be used to describe and identify the template, as well as optimally rendering and showing the related information captured by the template. In the case of blank template attribute values, undefined by the user, default values will be populated and/or determined by the heuristic and ML models (116, 124) whenever and wherever available and/or applicable.

In the “select template creation method” (311) step, the user can start the template creation from a blank template, an existing template with manual selection and/or machine intelligence recommendations per the template attribute values in step 310, a reference to an existing information structure such as a table of contents from a book, a syllabus from a course, a data or semantic model for a subject area, etc., or combination of one or any of the above.

If a template creation method is set to reference an information structure, the user can enter the information structure manually via keyboard entries, through voice dictation, and/or any other applicable and available human computer interface mechanics.

The information structure can also be loaded from one or multiple images, text files, and/or other MIME document types for machine intelligence processing and further edits. For image file(s), image recognition and text extraction techniques via on-device cognitive services (118) or AI/ML cognitive services with Generic & Domain-Agnostic Cloud Services (161) and the applicable interfaces (115). Additionally, the prompt-based interactive information capture method, as disclosed in the previous section (FIG. 2), can also be utilized for user-personalized information structure capture from a course's syllabus, a book's table of contents, or a data and semantic structure for a subject domain, given that the capture template for the specific information structure is already defined through the disclosed template definition and modification method. NLP and text analytics services and/or heuristics and ML models (116) on device (116 and 117), on the service side (124 and 125), and/or any applicable and available AI/ML/Information products, service, and models (160) can also be utilized to further process the content for more appropriate information structure processing. The user can also perform further reviews and edits with the processed information.

File types with text content, such as text files with ASCII or UTF encoding, Microsoft office files, PDF, and/or other applicable MIME types, can be loaded directly for information extraction with the appropriate content loading tools that can be custom built and/or implemented with third party products or services. NLP and text analytics services and/or heuristics and ML models on device (116 and 117), on the service side (124 and 125), and/or any applicable and available AI/ML/Information products, service, and models (160) can also be utilized to further process the content for more appropriate information structure processing. The user can also perform further reviews and edits with the processed information.

With the template creation method selected, the user proceeds to define a prompt-set for the template (312) by creating new prompt(s) and/or adding in existing prompts from the pre-existing prompts (111) on-device or prompts collection (121) on the server-side.

New prompts can be created by simply inputting a prompt's name and/or description with the system filling in, based on heuristic and ML models whenever and wherever applicable and/or available, the rest of the prompt attributes such as pop-up conditions, prompt processing options (as-is, image text extraction (logo, label, etc.), NLP (entity extraction, topic modeling, syntax, sentiment, text analytics, etc.), formatting and style options, etc.

In the case of template creation from a referenced information structure, as selected in step 311, the computer programs implementing the disclosed method will attempt to automatically create the corresponding prompts mapping to the information structure with the corresponding sequencing and nesting of the prompts, if applicable, with the assistance from the NLP and text analytics services and/or heuristics and ML models on device (116 and 117), on the service side (124 and 125), and/or any applicable and available AI/ML/Information products, service, and models (160) can also be utilized to further process the content for more appropriate information structure processing.

NLP and Text Analytics Services (125) and Heuristic and ML models (124) on the server-side can be utilized whenever and wherever applicable and/or available. The user can review and edit the generated prompts to refine and better reflect on the presented information structure they intend to capture.

Existing prompt-set template(s) on device or on server-side (112 or 122) may need to be modified to better suit the user's information capture needs for the applicable raw information contents and sources. Template modification can be conducted at the individual user's level pertaining to their individual needs, at a group level for a common theme(s) that may be applicable to one or multiple device users, and/or at the system level for all users. A need to modify a prompt-set template may be triggered manually per a user's individual or group capture needs such as capturing a course lectures personally or among a study group. It can also be triggered by machine intelligence augmented observations and learnings from the user's information capture and retrieval activities, new developments or advancements of the heuristic and machine learning models (12), and/or availability of data/cognitive/semantic models that may have an impact on how to relate and reorganize prompts and prompt-set templates.

In modifying an existing template, the user will first find and then load an existing template (320) from their own device (100) or server-side prompt-set template collection (122). The user then reviews the loaded template and, if applicable, modifies the template name and/or other template attributes (321). The user then proceeds to add and/or modify prompt(s) (322) regarding to the selected prompt's name and/or attribute modifications within the existing prompts in the loaded template. The user can also add new prompt(s) to the template, similar to the activities in step 312.

With the initial set of prompts created, added, and/or modified, the user proceeds to organize the prompts manually and/or automatically with machine intelligence mechanics (330) by specifying the prompt to prompt positions and relationships such as siblings, parent-child, display order, linkage with an affinity type or score, etc. Formatting and styles for the template can also be modified per user's preference within the template, prompt node or sub-node levels, default content format type(s) such as text, html, MS word, etc., and/or display mode such as document view, tree view, graph network, any other visual display types that might be applicable or available.

Steps for prompt organization (330) and prompt creation and/or modifications (312, 322) are iterative with backward and forward steps to make sure the capture template is refined to the user's desired capture needs.

After the user indicates that the template definition is completed, the completed template can be related to other template(s) and/or applicable information model(s) (331). The user can opt to manually relate the current template to other templates or information models (163) if they see fit.

Relationship(s) between the current template to other template(s) and/or applicable information models (163) can also be established via heuristic and machine learning models on device and/or on server-side (116 and 124) based on collective user behaviors in linking prompts, templates, and/or information models (163). Domain specific and/or purpose-built information models (163) in the form of knowledge taxonomies, data or domain models, cognitive models, semantic models, information theories, ontological models, etc. can also be integrated within the heuristic and machine learning models (116 and 124) to learn and infer applicable relationships. Information models can be for specific knowledge areas, industries, academic subjects, behavior types, and any other domains or purposes that can be leveraged by the heuristic and machine learning models to learn and/or infer the possible relationships.

After the linkage between template to other template(s) and applicable information models in step 331, the user reviews the template relationships, confirms and saves (332) the template.

### Prompt and Machine Intelligence Organized Information Retrieval and Interaction

Traditionally, people use different means of options that are available to them to capture information, which can be stored in one or multiple storage sources. Finding and retrieving the desired information from even one location or source with one or more than multiple files can sometimes be difficult, especially if the files are more than a few pages and the dimensions for searching are limited only to file names, keywords, and/or tags associated with the searched files.

Information retrieval from saved notes, an academic course across multiple places and/or sources can be even more challenging. For example, to study for a test, it is common for a student to spend a significant amount of time to search and gather the right information, which can take up 10% or 20% of the entire test preparation and study time. In situations like preparing for a final for an academic course, it might take a student more than 20% of the time to find and organize all the necessary lecture information and notes for the particular topic areas, with information that might be captured across different places and/or information sources.

The traditional means of information retrieval also do not present people with options to utilize the time, location, and process dimensions in finding the desired information based on where, when, and how the information is captured, which sometimes holds effective memory clues in finding and identifying the right information for retrieval.

The disclosed prompt-organized information retrieval method offers the following unique features:
Finding desired information with more dimensions such as when, where, and/or how an information piece is captured, wherein how is associated with the capture template, prompt, input mechanics and/or other types of information capture attributes associated with the prompt-based interactive information capture method;
Presenting the information more dynamically per the origination of the prompt-set associated to a template;
Gathering and linking the relevant information pieces per template relationship, prompt relationship, and existing knowledge or information taxonomy or models, etc.

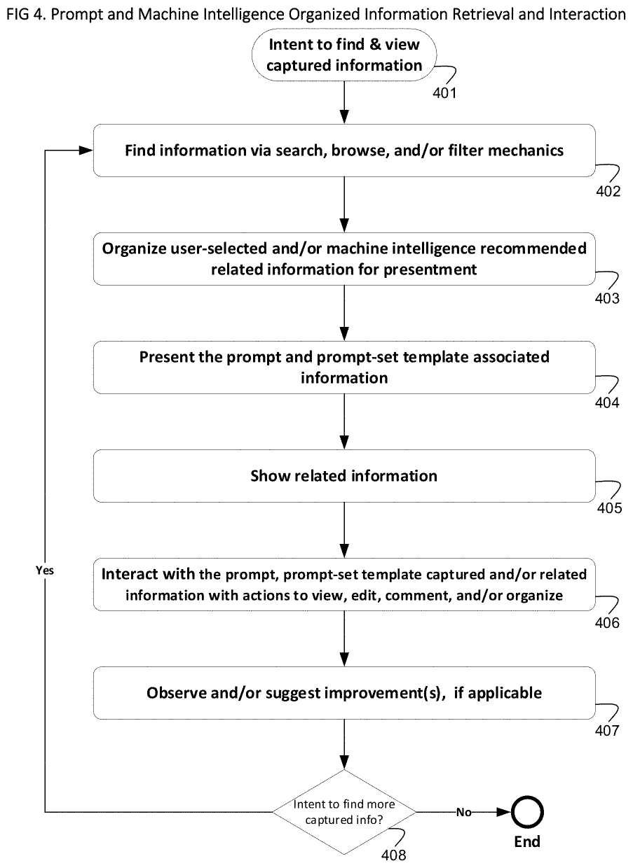

FIG. 4 illustrates the main process of prompt-organized interactive information retrieval, presentment, and linkage. Additional sub-processes or alternative processes are further elaborated in the rest of the section.

As illustrated, the main flow of the said method starts when a user intends to find and view captured information (401). A user begins to find information via search, browse, and/or filter mechanics (402) with the following attributes or dimensions:
Common attributes or dimensions: keywords, tags, subject areas or topics, by or within one or multiple categories the desired information might be associated with, etc.;
Disclosed invention's unique attributes or dimensions:
   times and/or locations of when the desired information is captured,
   attribute(s) and/or structure(s) associated with the templates and/or prompts the desired information might be captured under, and/or
   mechanics such as prompt processing options, input sources that the desired information is captured in or from;
suggestive search terms augmented by the machine intelligence capabilities that can be custom-developed and/or implemented from third-party products or services whenever and wherever applicable.

These attributes and/or dimensions can be used for search, browse, and/or filter mechanics wherever applicable and/or available following or leveraging any of the state-of-the-art information searching, browsing, and/or filtering practices that can be custom developed, procured and/or implemented via third-party products or services.

Human-device interactions involve searching, browsing, filtering, and/or interacting with the digital device for information retrieval and consumption. The process can be conducted via any of the device's input/output capabilities commonly available currently or in the future. Examples may include typing via keywords, hand gestures and/or stylus touches with the device, voice commands or interactions via speech to text and virtual assistant technologies such as the Google Assistant, Apple's Siri, Amazon's Alexa, and/or mind reading or brain-machine interfaces, which are currently being experimented by companies such as Facebook or Neuralink.

Upon identification of the desired information to retrieve via step 402, the computer programs (110) associated with the disclosed method organizes user-selected and/or machine intelligence recommended relative information for presentment (403) via the programming flows (113), heuristic and ML models (116) whenever and wherever applicable, and the input/output (114) component.

Related information, per the capture template set that the desired information is associated with and/or defined by the user's preference, can also be fetched and organized per the dimensions that the application may encompass. Examples include information related to a category or subject area, related to the class the desired information is associated with, within the capture template's structure as a sibling, parent, or child node information, related to other associated templates or prompts, or related to the location and timeline the information is captured, etc.

With the desired and/or related information identified, fetched, and organized, the user's digital device (100) presents the prompt and prompt-set template associated information (404) via the input/output (114) mechanism. The information associated with the capture prompt will be presented per the capture template's default display style and format, which might be in html, word, as an image, or any other applicable MIME content types, with options to display the desired information in other applicable format and style.

If applicable and available, the information pieces associated with the sibling prompt(s), parent prompt(s), child prompt(s), portions of the capture template associated prompt-set, and/or the entire prompt-set structure will also be presented as preceding or following information sections with scrollable and/or linkable content, side-bar or pop-up navigational pane links, or any other state of the art content visualization style and display mechanics that can be custom-built or implemented as third-party prompt products or services.

Information associated with the capture template's prompt-set can also be displayed in different view types such as with a top-down document view, tree view, connected graph view, topological view, and any other state of the art view types and visualization techniques built off the relationship and attributes of the prompts in the template via custom implementation and/or third-party products and services.

Related information to the information explicitly sought for in step 402 by the user is any information that may be connected to the queried information. The related information might be notes, tags, reminders, attributes about the information such as when, where, or how the information is captured, versioning information, logs, etc. explicitly or implicated captured by any user types, information pieces, prompts, prompt-set templates explicitly or implicitly linked by the user and/or any user or user types during the information capture, information retrieval and interaction, prompt definition, prompt template definition processes. The related information may also be inferred via the heuristic and/or machine learning models that can be custom built and/or implemented via third-party products or services based on user activities and setups, common or domain specific taxonomy, data, industry, knowledge, and/or semantic models.

If the related information is available, the user's digital device will also show the related information (405) as in the navigational pane, as a pop-up, or any other state of the art information visualization and display technique(s) that can be custom built and/or implemented via third-party products or services.

Related information can also be displayed in different view types similar to the view types in step 404 by leveraging any applicable state of the art view types and visualization techniques built off the related information gatherings via custom implementation and/or third-party products and services.

With the information in display, the user interacts with the prompt, prompt-set template captured and/or related information with actions to view, edit, comment, and/or organize the interacted information (406). View interactions with the prompt, prompt-set template, and/or related information are carried out via the navigation and view styles as described in steps 404 and 405. Edit actions refer to any changes or modifications to the interacted information and underlying attributes and meta-data. Examples include information content changes and edits, format changes, modifications to the related prompt(s) and/or prompt display preferences and options, edits of the information attributes and/or meta-data about the information, edits of the change logs, as well as any implicit and/or explicit logging about the edit action, including when, where, how, and/or what.

“Comment” actions refer to the user's actions towards the interacted information such as Noting, tagging, reminding and/or linking event(s) for later review(s) or check-up(s), ratings, and/or like(s)/dislike(s) pertaining to any aspect of the captured information. “Organize” actions refer to prompt reassignment, prompt positional changes within the capture template, ratings for information quality, linkages to other prompts or prompt-set template, and/or linkages to one or multiple information models wherever applicable and available.

During the information interaction step (406) with the user and the computer programs (110) that implement the disclosed method, observations of the user activities are made to gather insights and predictions to suggest improvement(s) and for continuous improvements, if applicable.

Insights and predictions can be gathered explicitly such as through user ratings of the extracted information. They can also be gathered and/or learned implicitly via observing the user interaction actions individually, collectively, or comparatively via heuristic and machine learning models on-device or on the server-side (116, 124).

During or after the information interaction step (406), if more information needs to be retrieved (408), which is not part of the prompt, prompt-set captured or related information, and/or if the desired information is not easily identifiable via the interaction and suggestion steps (406, 407), the user can go back to step 402 for find desired information via search, browse, and/or filter and continue further. Otherwise, the user can choose to end the information retrieval process.

The invention claimed is:

1. A prompt-based and machine intelligence augmented interactive information capture and retrieval system, comprising:
a) A plurality of digital devices, each digital device has computer programs implementing prompt-based and machine intelligence augmented interactive information capture and retrieval, device hardware components for user and information interactions, and/or additional third party apps or programs that may interface with the said computer program, wherein digital devices include mobile devices, personal and/or desktop computers, wherein device hardware components for user and information interactions include device display, memory, storage, camera, speaker, microphone, device sensors, stylus pen, and/or other device components supporting human-device interactions;
b) Server-side computer programs and common server-side components and software services running as cloud services, wherein cloud services refer to a wide range of computing and information technology services delivered on demand over the internet typically with a fee for service, wherein server-side includes cloud services and/or remote computing services and operations that a digital device may consume, wherein common server-side components and software services are common server-side infrastructure components and services including compute, memory, storage, network, platform services, security services and/or other applicable information technology services, wherein server-side software components and services including SDKs, libraries & frameworks, 3rd-party software or products, etc., which can be implemented by leveraging Infrastructure as a Service (IaaS), Platform as a Service (PaaS), Function, Data, Machine Learning, and any applicable as a Service Cloud offering commonly available from the market place;
c) Raw information sources containing raw information contents that a user is interested in capturing into one or multiple digital devices, wherein raw information sources may be one or multiple digital and/or physical sources, and raw information contents may be already stored on a user's digital device, stored remotely in one or multiple cloud storage services, stored in one or multiple internal file storage or systems, inside application or data systems, from one or multiple websites, from one or multiple physical media, presented on one or multiple screens of any size, and/or information heard and/or seen physically including flyers posted on physical places, speeches delivered over one or multiple audio channels, lectures presented in classroom with whiteboards, protectors, computer screens, and/or speeches, wherein in the case of digital information sources, raw information content may be of in any Multipurpose Internet Mail Extensions (MIME) or internet media types, wherein in the case of physical information sources, raw information contents may require a camera and/or an audio recorder to capture;
d) Third-party machine intelligence and information technologies, models, products, and/or services for computer vision, speech recognition, natural language understanding and processing, wherein information technologies products, models, or services are industry or domain specific datasets, information models, knowledge models, and/or ontology models;
e) Interfaces between the said digital devices, server-side computer programs and common server-side components and software services, raw information sources, and/or third-party machine intelligence and information technologies, models, products, and/or services.

2. The system of claim 1, wherein machine intelligence refers to artificial intelligence (AI) and machine learning (ML) technologies, products, services, and models that can be custom developed and/or implemented from third party products or services, which may continuously learn and improve over time in the said system due to continued availability, growth, and/or expansion of data and data sources within the said system internally and/or externally across the marketplaces, new or improved AI/ML technologies and algorithms available from the marketplace, research communities, and/or via internal development, wherein AI and ML are further comprised of rule-based and knowledge technologies for heuristic models, statistical, machine learning, and deep learning models for descriptive, predictive, and/or prescriptive models, natural language processing technologies for speech recognition, text analytics and understanding and extracting of required information segments from the prompt associated texts, and imaging recognition technologies that may utilize computer vision and deep learning technologies for imaging data processing and recognition.

3. The system of claim 1, wherein computer programs implementing prompt-based and machine intelligence augmented interactive information capture, organization, and retrieval further comprised of:
a) Prompts and prompt-set templates that are included in the computer program, retrieved from the server-side, and/or device-user defined, wherein prompts and prompt-set templates are defined by the said system, individual device users, group users with two or more device users sharing group level prompts or prompt set templates, wherein prompts are labels or tags defined by users manually and/or assisted by machine intelligence models, such that the said prompts may be interacted by device users to denote, reference, and/or group one or multiple pieces or types of information as determined noteworthy, which may be compromised of one or multiple characters, words, sentences, paragraphs, sections, chapters, books, images, voice recordings, and/or web or digital sources of any MIME types, wherein prompt-set template is a collection of two or more prompts for one or multiple information subject areas with varied prompt-to-prompt relations including siblings, hierarchical, relational, tree-like, graph-linked, and/or associated with one or multiple relationship types, characters, and/or affinity scores.
b) Computer implementations of the programming flows, functions, and controls supporting the said system;
c) Input mechanisms for capturing user interaction gestures, stylus pen interactions, and other input mechanics including text or voice commands via one or multiple keywords or a device's microphone, device's camera, or other device sensors that can receive or detect a user's input which may signal a command or instruction;
d) Output mechanics for gathering, organizing, and rendering the desired information for display;
e) Heuristics, ML, and/or NLP models or services that may be either custom-developed, from 3rd party service providers, running on-device as part of the computer program, or from another computer program, external system, or public cloud;
f) On-device machine intelligence services for speech recognition, computer vision, natural language processing, and/or other AI/ML services;
g) Computer interfaces for data communications in-device, device to device, and/or device to server-side services.

4. The system of claim 1, wherein server-side computer programs are further comprised of:
a) A prompt collection and prompt-set template collection across the system and client devices that are user-defined, system-defined, and/or machine intelligence augmented, wherein prompt collection and prompt-set template collections grow and refine over time with user feedback, usage data collection and observations, and machine intelligence analysis;
b) A collection of tag-based text extraction instructions for media file types including html, pdf, image files, etc., which can be instructed manually or via third party services;
c) Heuristic and ML models and NLP and text analytics services that may be custom-developed and/or implemented by third-party products or services,
d) Interfaces for communicating between server-side services and digital devices running the said computer programs implementing prompt-based and machine intelligence augmented interactive information capture and retrieval

5. The system of claim 1, wherein third-party machine intelligence technologies, products, models and/or services are further comprised of:
a) Generic and domain agnostic cloud services including AI/ML cognitive services, data models, cognitive and semantic models that are generic and not associated with any specific industry or scientific domain by AI/Data technology providers;
b) Libraries, frameworks, and/or tooling (162) that are provided as products or services that can be consumed as cloud services, implemented and run on-device, and/or implemented and run on server-side;
c) Purpose-built and domain specific AI/ML products or services and information models for a specific industry, consumer, or academic domains, online electronics data and semantic models, and any other domain and/or purpose specific AI, ML, and Data products or services.

6. A method for interactive information capture via user-defined and/or machine intelligence augmented prompts and prompt processing, comprising:
a) Need or intent to capture information from one or multiple raw information sources into a digital device, wherein need or intent may arise during and/or after the period where the raw information is presented or encountered, wherein raw information sources may be represented and/or display in any human comprehensible information format that a user may come across via human sensory perceptions like vision and/or hearing, which may be represented and/or displayed digitally or physically in one or multiple places, for a short or long period, and/or occurring once or multiple times;
b) Selecting a triggering action to indicate the information capture need and/or intent, wherein the triggering action is a predefined trigger exposed as a user interface component that a user may click or act on to signal the capture need and/or intent, which can be part of a third party app that interfaces with the computer programs implementing the said method, part of a custom built app for capturing one or multiple information subject areas that interfaces with the computer programs implementing the said method, wherein selecting the triggering action, the trigger action may send the triggering action name, type, and/or triggering action context that may include triggering action related intent types, information types, third party or custom implemented app names and/or types, app screen position and context the triggering action are being acted on, information capture context, location, time, and/or user generated information for the trigger action including notes, categorization, past behavior, modification, preferences, wherein selecting the triggering action, the computer programs implementing the said method may select a prompt-set capture template based on the information passed along with the triggering action, which may be defaulted per the trigger action name and/or type, and/or determined by machine intelligence inferences from the additional context info that may be passed via the triggering action, and/or the user may select a prompt-set template to override the computer selection;
c) Identifying and/or specifying one or multiple raw info contents and/or sources to capture;
d) Loading and displaying one or multiple raw information contents specified in the previous step from the associated info source or sources, one at a time if applicable, wherein in the case the raw information content is an audio file, transcribing the audio file to text via speech-to-text technologies that may be custom implemented and/or leveraging third-party services;
e) With the raw information content loaded, specifying one or multiple desired info areas or segments to capture;
f) Presenting a list of prompts for the user to select and associate the specified content with, wherein the list of prompts may contain all of the available prompts that are present in the prompt-set template, a portion of the prompts pertaining to the content in display and/or in selection, which may be configured by the user manually and/or determined by the machine intelligence models based on the analysis of the content on display, the bordering contents, and/or the related contents, wherein the list of prompts may be organized and presented top-down, nested in a hierarchical structure with parent or branch notes collapsible and expandable, appearing horizontally or vertically, stacked, circularly, and/or leveraging any other applicable visual display techniques that can be custom-developed or implemented via third-party products or services, wherein the list of prompts may have a custom prompt item in the case of no suitable prompt to select from that can be mapped to the specific information;
g) Selecting the appropriate prompt for the specified content in the previous step, or in the case of no suitable prompt to select from the list, defining a new custom prompt for the specific information area or segment, wherein the new custom prompt is defined by clicking on the custom prompt item with a user-defined prompt's name or label, and/or with additional prompt attributes to be populated if desired by the user;
h) Sending the specified information area or areas and/or information segment or segments for prompt processing;
i) Determining if more information areas and/or segments are to be captured and returning to the step of with the raw information content loaded, specifying the one or multiple desired info areas or segments to capture and continue forward if applicable; and/or
j) Determining if more raw information contents are to be capture and returning to the step of loading and displaying one or multiple raw information contents specified in the previous step from the associated info source or sources if applicable; and/or
k) Reviewing, re-organizing, refining, and/or commenting on the captured information if desired or applicable; wherein reviewing and refining are actions or activities for viewing, making changes, and/or modifying the interacted information, the underlying attributes, and/or the meta-data, including information content changes and edits, format changes, modifications to the related prompt(s) and/or prompt display preferences and options, edits of the information attributes and/or meta-data about the information, edits of the change logs, as well as any implicit and/or explicit logging of edits action, including when, where, how, and/or what, wherein re-organizing are actions or activities for making changes to prompt's reassignment, repositioning within the capture template, ratings for information quality, linkages to other prompts or prompt-set template(s), and/or linkages to one or multiple information models if applicable, wherein commenting are actions or activities about the interacted information such as noting, tagging, setting a reminder and/or linking event(s) for later review(s) or check-up(s), ratings, like(s)/dislike(s) pertaining to any aspect of the captured information.

7. The method of claim 6, wherein identifying and/or specifying one or multiple raw info contents and/or sources to capture may have raw information encountered at the same time of the capture need and/or intent, recorded via a camera and/or audio recorder on a digital device, and/or the raw information may be on one or multiple digital locations, which can be identified manually by selecting and specifying the applicable files from one or multiple sources, and/or specified and loaded automatically via file load utilities with the raw information content and/or source attributes or specifications, and/or augmented with machine intelligence models per the related triggering action and/or user interaction context and learnable patterns, wherein raw information content and/or source attributes or specifications may include image, audio, and/or video files captured during a certain time period in a certain geographical location, files with certain naming conventions and/or timestamps, files at particular locations, files within certain sizes or associated with certain users or entities, and any other attributes that can be used to identify the file content types and sources.

8. The method of claim 6, wherein specifying one or multiple info areas or segments are user interactive actions or activities with the digital device screen and/or microphone for specifying one or multiple information areas on a digital screen and/or one or multiple information segments that can be instructed with one or multiple information extraction dimensions and extracted via machine intelligence technologies, which is further comprised of:
a) specifying one or multiple information areas of interest with interactions on the device screen that may be carried out via typing, gestures or a stylus pen, and/or voice instructions, wherein gestures or a stylus pen may include touches, hold and/or drag, point and click, and/or drawings, which may include drawing a boxed, circled, or free formed areas, wherein voice instructions and/or drawings may include calling out and/or touching the screen area and/or content type, calling out and/or touching the corner positions, calling out and/or touching the begin and end positions or lines, calling out and/or touching a centroid's position with an extending area in radius or in width and height, or any other means that may specify an area of interest on a screen with the voice dictations and/or drawing via the device's microphone and the applicable speech recognition services for screen area specification; and/or
b) specifying one or multiple information segments with one or multiple information extraction dimensions, wherein information extraction dimensions may include one or multiple tags, named entities, topics, labels, parts of speech, synonyms, antonyms, places, times, concepts, elements in images such as text, signs, object types, and/or text entities and context that may be extracted via marketplace available and/or custom implemented natural language processing and/or image recognition technologies, wherein information segment extraction dimensions may be prompt inferred or related that are pre-defined with the associated prompt, user specified, based on the user's preferences and/or configurations, past behaviors, combined with raw information content context like containing sentences, paragraphs, text blocks, and/or related images, and/or from collective screen interaction intelligence for similar content types.

9. The method of claim 6, wherein prompt processing refers to extraction, organization, and/or formatting and styling of the desired information from one or multiple raw information contents as denoted by the specified prompt via human cognitive and/or machine intelligence processes per the prompt's associated information extraction, organization, and/or formatting configurations, which further comprises:
a) Extracting user-intended information based on the prompt's associated and/or user specified information extraction dimensions from the selected information areas or segments, which may include time and/or location the information is captured, extracting as-is for the specified information area or areas, and/or extracting per the information segment extraction dimensions utilizing machine intelligence models and technologies; and/or
b) Applying formatting and/or styling to the extracted text and/or visual components such as images or charts per the prompt and/or user specified formatting and styling instructions, including colors, text sizes and fonts, shapes and sizes preferences for visual elements, alignments, indentations, positions, and/or any other available or applicable content formatting and styling techniques that may be custom built and/or implemented with third party products and/or services;
c) Wherein in the case of a visual element like an image or chart is sent for prompt processing, the prompt and/or user specified information extraction instruction or configuration may be processed as-is without image recognition applied, Optical Character Recognition (OCR) or text recognition from an image, object labeling, facial recognition, logo or brand detection, and/or other image recognition tasks that may be custom developed and/or implemented with third-party technologies and services;
d) Wherein prompt processing instructions may be predefined with the prompt and/or the prompt-set template, pre-defined with the MIME types the information may be associated with, configured by a user with user selectable prompt processing instruction for information extraction, organization, and/or formatting and styling as part of the prompt definition process or during the capture time.

10. The method of claim 6, wherein re-organizing and/or refining the captured information may occur after the device user is done with the interactive information capture event with one or multiple intelligence models custom developed and/or implemented with third-party technologies or services, which may be performed overtime iteratively and/or triggered by availability of new data and/or models, and is further comprised of:
a) Organizing the information per the available information dimensions within the captured information and/or in relationships to other captured information, which may include locations, time sequences, content similarities, themes, applicable and available information and/or knowledge models related to the captured information; and/or
b) Organizing the information per the continuous observations on how the organization of the respective information is preferred or not-preferred by users in their actions in viewing and/or changing the information, including user feedback such as likes or dislikes, wherein in the case of user viewing the captured information, the machine intelligence model organized information views will be displayed as secondary and/or related views if a user selected view is already in place.

11. A method for user-defined and/or machine intelligence augmented prompt-set template creation and/or modification, comprising:
a) Need and/or intent for capturing one or multiple information contents and/or sources that may require one or more prompts;
b) Determining if the need and/or intent may require creating a new prompt-set template or modifying an existing prompt-set template, which may be determined individually at the user level, individually or collectively at the group level with two or more users, and/or at the system level with the computer programs implementing the said method across the users as common services, wherein determination of creating a new or modifying an existing template may be based on search or browse of similar prompt-set templates for the target information area or areas on the device or from the server-side prompt-set template collection, subjective and/or intuition based at the user level with redundant or similar entries create on user devices, performed via keywords, tags, categorizations, and/or machine intelligence augmented assistance for matching templates, and/or interacted via keyboard entries or voice instructions interpreted by speech-to-text machine intelligence technologies from a third-party and/or custom developed;
c) Upon determination that a new prompt-set template is needed, creating a new prompt set template with template name, attributes, and/or target information properties, wherein template attributes may include description, category or theme, display style and format, usage patterns or guidelines, complexity, number of prompts, levels or types of related information to show, and/or any other attributes that may be used to describe and identify the template, as well as optimally rendering and showing the related information captured by the template, wherein in the case of no template attribute values are defined by the user, default values may be populated and/or determined by the machine intelligence models if applicable;
d) Continuing new prompt-set template creation by selecting a template creation method, which may be from a blank template, from an existing template, referencing an information structure;
e) With the template creation method selected, proceeding to define a prompt-set for the template by creating one or multiple new prompts and/or adding in one or multiple existing prompts from the existing prompt collection on-device and/or from the prompt collection on the server-side, wherein existing prompts may need to be modified to better suit the desired information capture needs for the applicable raw information contents and sources, which may be at the individual user's level pertaining to the device user only, at the group level for two or more device users, and/or at the system level for across all users as common services;
f) Upon determination of modifying an existing template, loading the existing template from the device or server-side, proceeding to modify the loaded template;
g) With the set of prompts created, added, and/or modified, organizing the prompt-to-prompt relationship and rendering visuals manually and/or automatically with machine intelligence assistance if applicable; and/or
h) Steps for prompt organization and prompt creation and/or modifications are iterative with backward and forward steps to make sure the capture template is refined to the user's desired capture needs; and/or
i) Upon completion of a new prompt-set template creation or existing prompt-set template modification, the completed template may be linked to other templates and/or available information models if applicable, which may be linked manually and/or assisted via machine intelligence models by an individual user, collectively by two or more users for group level template, and/or at the system level across all users, wherein machine intelligence models for analyzing and predicting possible linkages among prompt-set templates may be based on collective user behaviors in linking prompts, templates, and/or information models, and/or domain specific and/or purpose-built information models in the form of knowledge taxonomies, data or domain models, cognitive models, semantic models, information theories, ontological models, etc. can also be input for the heuristic and machine learning models to learn and infer applicable relationships.

12. The method of claim 11,
a) Wherein users may include development and operations users implementing the said method, individual device users, and/or group users with two more device users sharing group level prompts or prompt set templates;
b) Wherein the need to create or modify a prompt-set template may be triggered manually per a user's individual or group capture needs, triggered by machine intelligence augmented observations and learnings from the information capture and retrieval activities across the users, from new developments or advancements of the machine intelligence models and technologies, from availability of new data and/or knowledge models that may have impacts on how to relate and reorganize prompts and prompt-set templates;
c) Wherein prompt set template creation or modification may be performed on the server side and/or on the client-side iteratively and/or collaboratively with one or multiple users, with client-side prompt and template creation and modification tools supporting device user prompt or prompt-set template creation or modification needs;
d) Wherein information subject area refers to a collection of one or multiple information elements describing one or multiple things, entities, persons, places, events, situations, concepts of any type, and/or relationship between one or any number of them, whereby information elements may be represented and/or presented in digital format of one of multiple MIME types, physically via print media, audio and/or video displays, and/or combination of both.

13. The method of claim 11, wherein continuing new prompt-set template creation by selecting a template creation method is further comprised of:
a) Starting the template creation from a blank template or from an existing template that may be manually selected and/or recommended by machine intelligence models based on the available template attribute values and the intended information subject area or areas; and/or
b) Referencing an existing information structure that the intended information subject area or areas may be associated with, which may include table of contents from a book, a syllabus from a course, and/or an information or knowledge model for the intended subject area or areas, whereby the information structure may be entered manually via keyboard entries, through voice dictation, and/or any other applicable and available human computer interface mechanics, wherein in the case that the information structure may be retrieved as text content represented in one of MIME types, text scraping and machine intelligence technologies may be utilized to extract the necessary information from the information source for information structure processing, assisted by the appropriate content loading tools that can be custom built and/or implemented with third party products or services.

14. The method of claim 11, wherein creating a new prompt is further comprised of:
a) Simply populating a prompt's name, with the rest of the prompt attributes unpopulated, which may be filled in with default values and/or manually with assistance from machine intelligence models, wherein prompt attributes may include a description, pop-up conditions, prompt processing options such as as-is, image log or text extraction, text segment extraction via NLP technologies including entity recognition, topic modeling, syntax, sentiment, text analytics, text processing instructions based on html, xml, json tags, text property specification, and/or formatting and style options, and/or
b) Reviewing the newly created prompt or prompts generated by referencing an information structure, editing the generated prompts to refine and better reflect on the presented information structure they intend to capture; and/or
c) Specifying prompt-processing instructions in terms of information extraction dimensions, and/or formatting and styling instructions, which may be filled with default values if not specified, wherein information extraction dimensions may include one or multiple tags with or without tag specific processing instructions, named entities, topics, labels, parts of speech, synonyms, antonyms, places, times, concepts, elements in images such as text, signs, object types, and/or text entities and context that may be extracted via marketplace available and/or custom implemented natural language processing and/or image recognition technologies.

15. The method of claim 11, wherein modifying an existing template for the intended information subject areas are further comprised of:
a) Modifying the template name and/or other template attributes where applicable for the intended information subject area or areas;
b) Adding new or modifying existing prompts in terms of prompt name and/or prompt attributes, which may be manually entered and/or assisted by machine intelligence models; and/or
c) Reviewing, if applicable, user feedback, notes, and/or observations by the machine intelligence model for the existing template as input to the modification.

16. The method of claim 11, wherein organizing prompt-to-prompt relationship and rendering visuals are further comprised of:
a) Specifying prompt-to-prompt relationships within the prompt-set template, wherein relationship may be specified by the prompt to prompt positions and relationships such as siblings, hierarchical, relational, tree-like, graph-linked, and/or associated with one or multiple relationship types, characters, and/or affinity scores, wherein specifying may be performed manually and/or assisted by machine intelligence models; and/or
b) Specifying rendering visuals for the extracted information associated with the prompt set, wherein rendering visuals are the visual displays for the information with the prompts in terms of look and feel and the associated formatting and styling.

17. A method for prompt and machine intelligence augmented information retrieval and interaction, comprising:
a) Need and/or intent to find and view captured information relating to one or multiple information subject areas;
b) Finding the information via search, browse, and/or filter activities leveraging the information dimensions and insights captured during the information capture process;
c) Organizing the found information with linkage to related information if available, wherein the found information is first organized per the rendering visuals defined and associated with the prompt and/or prompt-set template the found information is captured with, wherein the found information may also be organized based on use preferences and/or behavioral patterns in viewing the similar types of information observed and recommended by on-device and/or server-side machine intelligence models, which can be custom developed and/or via third party machine intelligence services, wherein related information may be gathered from the prompt-to-prompt relations defined by the capture prompt-set template that the found information is associated with, related to the location and/or timeline the information is captured, related to an information category and/or a domain specific information subject model, a social, academic, school, and/or business event or series of events the information may be associated with, and/or any other information to information relationships that might be discoverable via machine intelligence and data technologies;
d) Presenting the organized information that are associated with a prompt and/or prompt-set template via the user digital device display for information viewing and interaction;
e) Showing the related information to the information in display if available, wherein related information may be shown in the navigational pane, as a pop-up, or any other state-of-the-art information visualization and display technologies that can be custom built and/or implemented via third-party products or services;
f) Interacting with the prompt, prompt-set template captured information and/or related information with actions to view, edit, comment, and/or organize, wherein view actions are read-only interactions with the information on display; wherein edit actions are related to modifications to the interacted information and underlying attributes and meta-data, which may include information content changes and edits, format changes, changing the related prompt or prompts, prompt display preferences and options, edits of the information attributes and/or meta-data about the information, edits of the change logs, and/or any implicit or explicit logging about the edit action, including when, where, how, and/or what regarding the associated edit action; wherein comment actions may include noting, tagging, reminding and/or linking event(s) for later review(s) or check-up(s), ratings, and/or likes or dislikes; wherein organize actions are user interactions that may include re-arranging the information display order and/or display style in association with the prompts, reassigning the information associated with one or multiple prompts, changing prompt positions within the capture prompt-set template, ratings for information quality, linkages to other prompts or prompt-set template, and/or linkages to one or multiple information models if applicable; and/or
g) Capturing user information interaction activities to suggest additional or missing information, differing viewing options and/or rendering visuals, analyzing use needs and challenges for opportunities to create new or modifying existing prompts and prompt-set template; wherein additional or missing information, rendering visuals may be suggested in real time or after the fact based on user preferences, past behaviors, peer behaviors and activities for interacting with similar type of information subject area or areas augmented by machine intelligence models, wherein analyzing user needs or challenges may be gathered explicitly via user comments, and/or learned implicitly via observing the user interaction activities individually, collectively, or comparatively via heuristic and machine learning models on-device or on the server-side; and/or
h) Determining if the retrieved information, including the related information, is sufficient for the desired information subject area or areas originally sought for, or returning to the start of the said method to find additional information if more information is needed or missing.

18. The method of claim 17, wherein finding the information via search, browse, and/or filter activities are further comprised of:
a) Finding information via commonly practiced information attributes and/or dimensions including keywords, tags, subject areas or topics, indices, by or within one or multiple categories the desired information might be associated with, ranking; and/or
b) Finding information via the attributes and/or dimensions specific during the information capture process, including times and/or locations of when the desired information is captured, attributes and/or structures associated with the templates and/or prompts the desired information might be captured under, mechanics such as prompt processing options, input sources that the desired information is captured in or from; and/or
c) Finding information via suggestive search terms augmented by machine intelligence models where applicable and/or available, which may be custom developed and/or implemented from third-party products or services; and
d) Wherein the attributes and/or dimensions may be used for search, browse, and/or filter activities following or leveraging any of the state-of-the-art information searching, browsing, and/or filtering practices that maybe be custom developed, procured and/or implemented via third-party products or services; and
e) Wherein finding information is performed via human-device interactions via any of the device's input/output capabilities commonly available currently or in the future, including include typing via keywords, hand gestures and/or stylus touches with the device, voice commands or interactions via speech to text and virtual assistant technologies, and/or mind reading or brain-machine interfaces that are being experimented.

19. The method of claim 17, wherein presenting the prompt and/or prompt-set template associated information, the information is presented per the default display styles and formats of the capture prompt, prompts, and/or prompt-set template, which might be in html, word, as an image, or any other applicable MIME types,
a) Wherein the information may also be presented in alternative format and/or display style if defined and/or associated with the capture prompt, prompts, and/or prompt-set template;
b) If applicable and available, the information pieces associated with the sibling prompt(s), parent prompt(s), child prompt(s), portions of the capture template associated prompt-set, and/or the entire prompt-set structure will also be presented as preceding or following information sections with scrollable and/or linkable content, side-bar or pop-up navigational pane links, or any other state-of-the-art content visualization style and display mechanics that can be custom-built or implemented as third-party prompt products or services;
c) Information associated with the capture template's prompt-set can also be displayed in different view types such as with a top-down document view, tree view, connected graph view, topological view, and any other state-of-the-art view types and visualization techniques built off the relationship and attributes of the prompts in the template via custom implementation and/or third-party products and services;
d) Related information to the information explicitly sought for in step 402 by the user is any information that may be connected to the queried information. The related information might be notes, tags, reminders, attributes about the information such as when, where, or how the information is captured, versioning information, logs, etc. explicitly or implicated captured by any user types, information pieces, prompts, prompt-set templates explicitly or implicitly linked by the user and/or any user or user types during the information capture, information retrieval and interaction, prompt definition, prompt template definition processes. The related information may also be inferred via the heuristic and/or machine learning models that can be custom built and/or implemented via third-party products or services based on user activities and setups, common or domain specific taxonomy, data, industry, knowledge, and/or semantic models.
